(19) United States
(12) Patent Application Publication
(10) Pub. No.: US 2006/0023174 A1
(43) Pub. Date: Feb. 2, 2006

(54) Projector apparatus having an aperture-controllable diaphragm

(75) Inventors: Yi-Hao Kang, Hsinchu (TW); Chu-Ming Cheng, Hsinchu (TW); Wan-Chiang Wang, Hsinchu (TW); Che-Shine Tsai, Hsinchu (TW); Jyh-Horng Shyu, Hsinchu (TW)

Correspondence Address: BRUCE H. TROXELL, SUITE 1404, 5205 LEESBURG PIKE, FALLS CHURCH, VA, 22041, US

(73) Assignee: Young Optics Inc.

(21) Appl. No.: 11/140,933

(22) Filed: Jun. 1, 2005

(30) Foreign Application Priority Data
Jul. 30, 2004 (TW) 93122956

(51) Int. Cl. G03B 21/00

(52) U.S. Cl. 353/97

(57) ABSTRACT

A projector apparatus includes: a light source, a digital micromirror device for modulating the light beams emitted from the light source into photo signals, an illuminating lens unit for guiding the light beams emitted from the light source towards the digital micromirror device, and an imaging lens unit for guiding and projecting the photo signals generated by the digital micromirror device. into an image. An aperture-controllable diaphragm is disposed in the apparatus, and defines an aperture. The diaphragm includes at least one adjustable blade for altering dimension of the aperture so as to adjust the brightness and contrast of the image.

### FIELD OF THE INVENTION

The invention relates to a projector apparatus, more particularly to a projector apparatus that uses digital light processing technology and that includes an aperture-controllable diaphragm for altering the brightness and contrast of an image presented by the projector apparatus.

### BACKGROUND OF THE INVENTION

A projector apparatus of today uses digital light processing technology to process the photo signal and the image is later projected onto the wall screen. Therefore, today's projector apparatus serves an integral part of a home theater system.

Note that the digital light processing technology is capable of modulating electrical signals into digital light signals which are later projected into images onto the large screen via an image lens unit. A semiconductor chip (generally known as a DMD: Digital Micromirror Device) is used in the projector apparatus, and includes millions of tiny mirrors. Each of the tiny mirrors is made from aluminum alloy, and has a cross-section of 14×14 micro millimeter that is smaller than cross-section of a single hair strand.

FIG. 1 shows the DMD chip 10 having several millions of tiny mirrors 12. As illustrated in FIG. 1A, each tiny mirror 12 is rotatable about the a-b axis. FIG. 1B shows a cross-sectional view of the tiny mirror 12 taken along 8-8 lines in FIG. 1A, wherein the mirror 12 rotates 12 degrees in the anti-clockwise direction with respect to the a-b axis in case the tiny mirror 12 is at the “On” status, where the reflective light beam L₁ of the incoming light beam L₀ is directed to the projector lens unit 14 so as to project the image on the screen. On the other hand, the tiny mirror 12 rotates 12 degrees in the clockwise direction with respect to the a-b axis in case the former is at the “Off” status, where the reflective light beam L₂ of the incoming light beam L₀ is directed away from the projector lens unit 14. Since the digital information is referred to either “1” or “0”, the tinny mirror 12 rotates about the a-b axis in “On” and “Off” statuses.

Referring to FIG. 2, a conventional projector apparatus 20 (generally known as DLP projector) using digital light processing technology is shown to include a light source 22, an illuminating lens unit 24 for defining a light path of the light beams emitted from the light source 22, a DMD chip 10, a total internal reflection prism 26, and an imaging lens unit 28.

The light source 22 can be a bulb or a lamp so long as it can produce light beams thereof. Preferably, a light collecting shield can be used to collect the light beams to travel in the light path. Each of the illuminating lens unit 24 and the imaging lens unit 28 may include several optical pieces depending on its utility thereof. A color filter wheel 23 having red, green and blue is disposed frontward of the light source 22 in order to provide multi-colors effect. The illuminating lens unit 24 preferably includes a light integrator 241 which directs the light beams to fully and uniformly reflect into the prism 26 via a reflective mirror 25. Later, the prism 26 directs the light beams into the DMD chip 10 with a predetermined angle of incidence so that the DMD chip 10 when in the “On” status decodes the digital light signal and reflects the same into the imaging lens unit 28. Finally, the imaging lens unit 28 focuses and projects the image onto the wall screen. In the aforesaid projector apparatus, the imaging unit 28 is disposed parallel with the illuminating lens unit 22 in order to reduce the dimension thereof and the light beams emitted by the light source 22 are directed perpendicularly to the prism 26 with the assistance of the reflective mirror 25 such that the reflected light beams travel in a direction parallel with the emitted light beams. In addition, there still is another conventional DLP projector using three DMD chips, each is responsible for producing a specific color.

However, the conventional DLP projector is unable to produce images of different brightness and contrast required according to the circumstances. For example, when used in a conference for presenting an intended scheme. Since the lighting in the conference room is not switched off, the higher the brightness the projector has, the clearer the image will be projected on the wall screen. In case, the conventional DLP projector is used as part of a home theater system, the image projected onto the wall screen is required to be in better contrast since the auditorium enjoy the movie in darkness and since the image should be in adversely contrast with the dark environment. Under this condition, a projector with lower brightness is preferred. The brightness and contrast provided by the conventional DPL projector cannot be altered. Referring again to FIG. 2, the light beam entering the prism 26 via the illuminating lens unit 24 is generally annular in cross-section, but the reflected light beam generated by DMD chip 10 is rectangular in cross-section. Therefore the final image projected by the projection lens unit may have peripheral halo phenomenon by virtue of cross-section differences between the light beams.

### SUMMARY OF THE INVENTION

The object of the present invention is to provide a DLP projector including an aperture-controllable diaphragm defining an aperture for extension of light beams therethrough. The dimension of the aperture in the diaphragm can be altered in order to provide different brightness and contrast of the image so as to eliminate the drawbacks resulting from the use of the conventional DLP projector.

A projector apparatus according to the present invention includes: a light source; a digital micromirror device for modulating the light beam emitted from the light source into photo signals; an illuminating lens unit for guiding the light beams emitted from the light source towards the digital micromirror device; an imaging lens unit for guiding and projecting the photo signals generated by the digital micromirror device out of the projector apparatus to present an image; and at least an aperture-controllable diaphragm disposed within the projector apparatus, and defining an aperture. The diaphragm includes at least one adjustable blade for altering dimension of the aperture so as to alter the brightness and contrast of the image.

An aperture-controllable diaphragm according to the present invention is proposed for use in a projector apparatus which includes a light source, a digital micromirror device for modulating the light beams emitted from the light source into photo signals, an illuminating lens unit for guiding the light beams emitted from the light source towards the digital micromirror device, and an imaging lens unit for guiding and projecting the photo signals generated by the digital micromirror device out of the projector apparatus to present an image. The aperture-controllable diaphragm is disposed within the projector apparatus, defines an aperture, and includes: at least one adjustable blade for altering dimension of the aperture so as to adjust brightness and contrast of the image.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic diagram of a DMD chip;

FIG. 1A is an enlarged view of a tiny mirror employed in the DMD chip shown in FIG. 1;

FIG. 1B illustrates how the tiny mirror reacts in response to the light beam under “On” or “Off” status;

FIG. 2 shows components of a conventional DLP projector apparatus which utilizes the chip shown in FIG. 1;

FIG. 3 shows the components of the first preferred embodiment of a DLP projector apparatus according to the present invention;

FIG. 3A shows the components of the second preferred embodiment of a DLP projector apparatus according to the present invention;

FIG. 3B shows the components of the third preferred embodiment of a DLP projector apparatus according to the present invention;

FIG. 4 shows an exploded view of an aperture-controllable diaphragm employed in the DLP projector apparatus of the present invention;

FIG. 4A shows a top planar view of the aperture-controllable diaphragm of FIG. 4, wherein the latter defines an aperture of predetermined dimension;

FIG. 4B shows a top planar view of the aperture-controllable diaphragm of FIG. 4, wherein the latter defines an aperture of another dimension; and

FIG. 5 shows an exploded view of another aperture-controllable diaphragm employed in the DLP projector apparatus of the present invention.

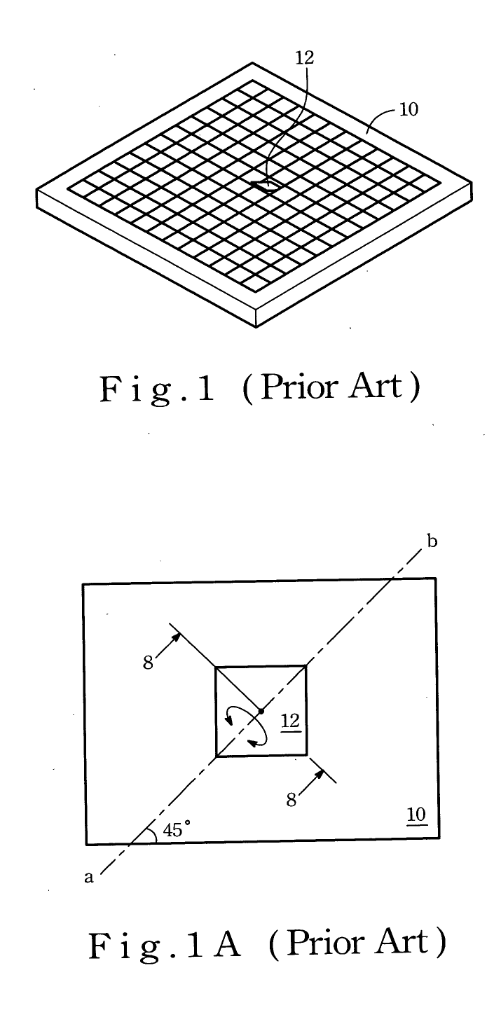

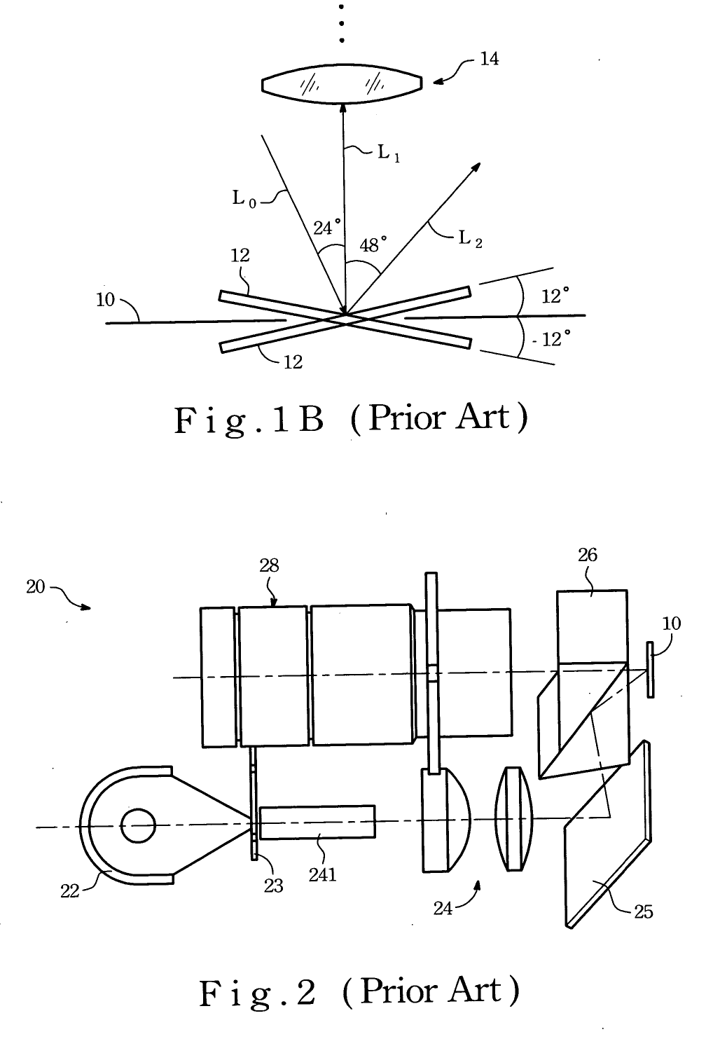

### DETAILED DESCCRIPTIONS OF THE PREFERRED EMBODIMENTS

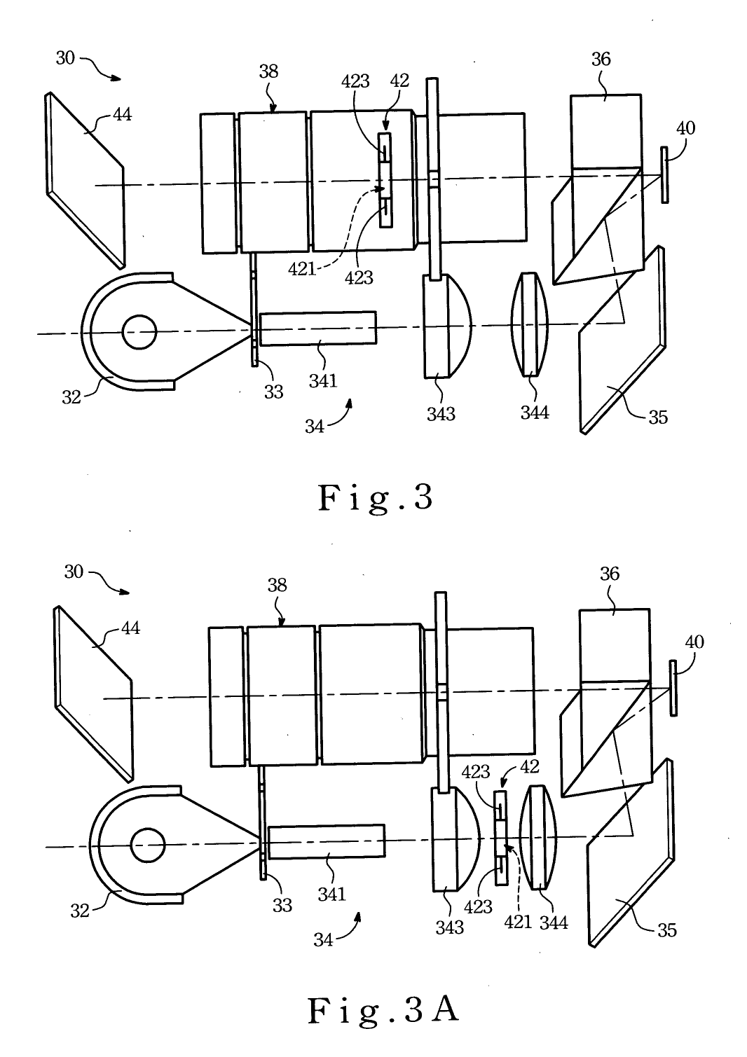

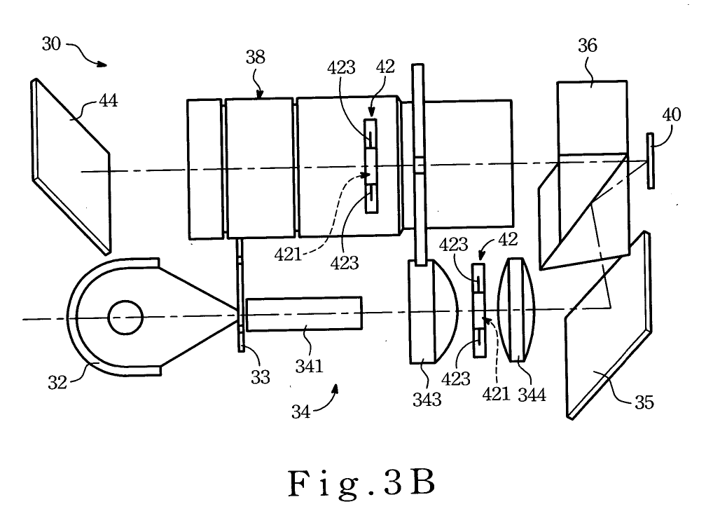

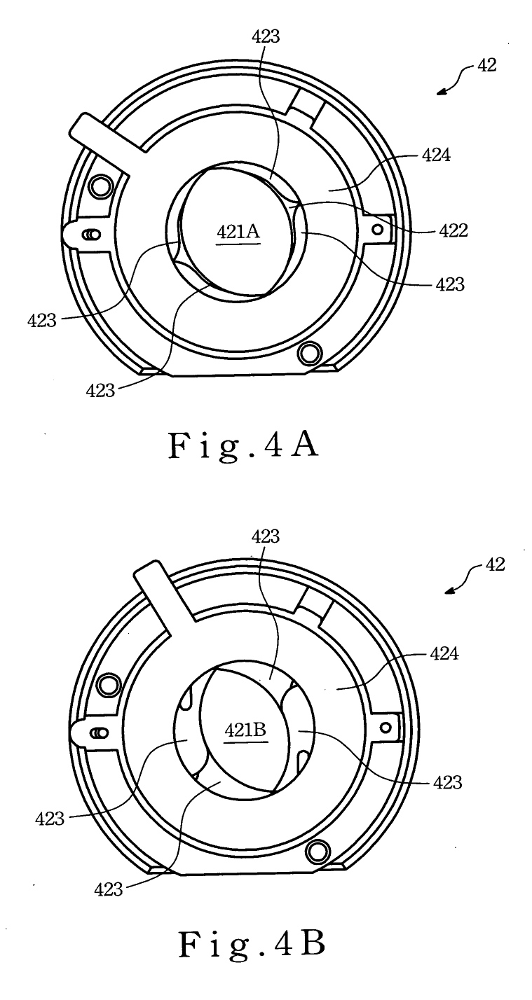

Referring to FIG. 3, the first embodiment of a DLP projector apparatus 30 according to the present invention is shown to include a light source 32, an illuminating lens unit 34, an imaging lens unit 38, a DMD chip 40, and an aperture-controllable diaphragm 42.

The light source 32 can be a bulb or a lamp so long as it can produce light beams. A light collecting shield is preferably employed in order to prevent light dispersion so as to direct the entire light beams emitted by the light source 32 into the illuminating lens unit 34, wherein the light beams are directed into the DMD chip 40 via a reflective mirror 35 and a total internal reflection prism 36.

The illuminating lens unit 34 includes two optical lens 343, 344 and a light integrator 341 which reflects the light beams uniformly and totally such that after hitting the reflection prism 36, the light beams reflected from the reflective mirror 35 enter into the DMD chip 40 with a predetermined angle of incidence ranging 10 to 14 degrees.

The DMD chip 40 modulates the light beams into photo signals which are latter decoded when the micromirrors in the chip are at the “On” status. The imaging lens unit 38 preferably includes several optical lenses in order to provide the magnifying and focusing ability of the image. The imaging lens unit 38 projects the decoded digital information onto the screen 44 in the image format.

The diaphragm 42 is disposed midway of the light path of the projector apparatus, and includes a plurality of movable blades 423 cooperatively defining an aperture 421 to permit extension of the light beams therethrough. Referring to FIG. 3, in the first embodiment, the diaphragm 42 is mounted in the imaging lens unit 38. Varying the dimension of the aperture 421 in the diaphragm 42 can alter the brightness and contrast of the image projected by the image lens unit 38.

FIG. 3A illustrates the second embodiment of a projector apparatus of the present invention, wherein the diaphragm 42 is disposed between the optical lens 343, 344 of the illuminating lens unit 34. FIG. 3B illustrates the third embodiment of a projector apparatus of the present invention is shown to include two diaphragms 42, which are respectively mounted in the illuminating lens unit 34 and the imaging lens unit 38 in order to provide a better brightness and contrast of the images. It is to note that the position of the diaphragm 42 within the projector apparatus should not be limited as shown in the aforesaid three embodiments. The diaphragm 42 can be disposed anywhere within the projector apparatus so long as the light path can pass through therethrough.

Referring again to FIG. 3, the first embodiment of the projector apparatus of the present invention further includes a color filtering wheel 33 for filtering the white light alternatively in such a manner to provide multicolor effects. The dimension of the first embodiment can be reduced relatively small by virtue of parallel position between the illuminating lens unit 34 and the imaging lens unit 38. Under such arrangement and by correcting the position of the reflective mirror 35 with respect to the reflection prism 36, the reflective mirror 35 can reflect the light beams perpendicularly therefrom toward the reflection prism 36. Alternatively, in another embodiment of the present invention, the assembly of the light source 32, the color filter wheel 33 and the illuminating lens unit 34 can be arranged in such a manner to be perpendicular with respect to the imaging lens unit 38 without employment of the reflective mirror 35 in the projector apparatus (not shown in FIG. 3).

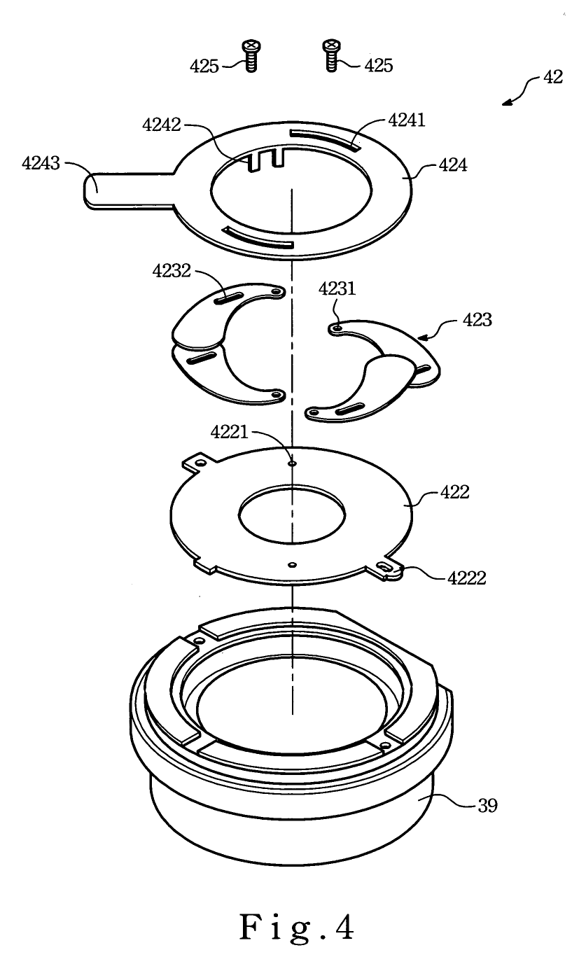

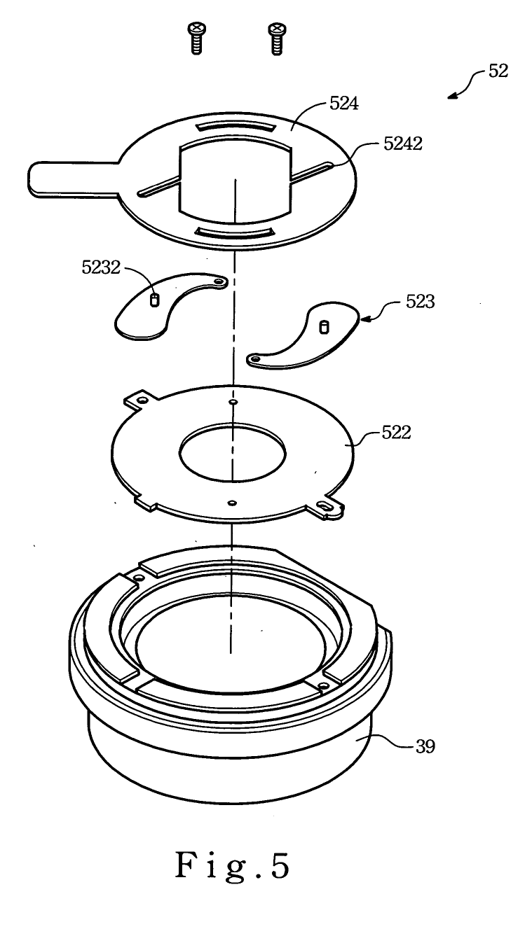

FIG. 4 shows an exploded view of the diaphragm 42 employed in the DLP projector apparatus of the present invention to include a lower plate 422, an upper plate 424, two pairs of pivotally-connected blades 423, and a fastener member preferably two screws 425. Each of the upper and lower plates 424, 422 is formed with a central light-passing hole for extension of the light beams therethrough. The lower plate 422 has two radial stems 4222 mounted securely on the mounting seat 39. The mounting seat 39 is preferably made from plastic material. The upper plate 424 is formed with two diametrically disposed guiding slots 4241. The blades 423 are sandwiched between the upper and lower plates 424, 422. The screws 425 respectively extend through the guiding slots 4241 in the upper plate 424, the through holes 4231 in the blades 423, and are threaded into the threaded hole 4221 in the lower plate 422. Under this arrangement, when the upper plate 424 is rotated relative to the lower plate 422, the adjustable blades 423 are driven by the upper plate 424 to rotate about the screws 425 as the rotating centers so as to alter the dimension of the aperture 421 in the aperture-controllable diaphragm 42. In the present embodiment, one pair of the blades 423 is formed with a tongue-engaging recess 4232 defined by a recess-confining wall. The upper plate 424 has an engaging tongue 4242 extending downwardly from a lower surface thereof to engage the recess-confining wall of the recess 4232 in the blades 423 such that the blades 423 simultaneously rotate together with the upper plate 423 about the screws 425 relative to the lower plate 422. To facilitate turning of the upper plate 424 with respect to the lower plate 422, the upper plate 424 is provided with a gripping stem 4243 that extends radially and outwardly from the outer periphery of the plate 424.

FIG. 4A illustrates a top planar view of the diaphragm 42, wherein the aperture 421 of the latter is shaped as a human eye 421A (or an oval) by virtue of simultaneous turning of the upper plate 424 and the blade 423 with respect to the lower plate 422. Under such a condition, the dimension of the 421A is generally equivalent to the dimension of the central hole in the lower plate 422 (see FIG. 4).

FIG. 4B illustrates another top planar view of the diaphragm 42, wherein the aperture 421 of the latter is shaped as a human 421B by virtue of simultaneous turning of the upper plate 424 and the blade 423 with respect to the lower plate 422. Note that the human eye 421B has a dimension smaller that the human eye 421A (i.e. 421B is smaller than the dimension of the central hole in the lower plate 422). Since the dimension of the aperture 421 in the diaphragm 42 can be adjusted according to the requirement of the user, thereby adjusting the entry of light beams into the diaphragm 42 in the projector apparatus.

Note that the structure of the upper plate 424, the lower plate 422 and the adjustable blade 423 for forming the diaphragm 42 can be in various configurations. The main feature and spirit of the present invention is to alter the dimension of the aperture 421 in the diaphragm 42 employed in the digitally operated projector apparatus so that the brightness and contrast of the image can be corrected according to the requirement of the user. Furthermore, by virtue and presence of the aperture 421 of the diaphragm 42 shaped as a human eye 421A or an oval, the occurrence of “halo phenomenon” as encountered during use of the conventional DLP projector apparatus can be avoided.

Referring to FIG. 5, an exploded view of a modified diaphragm 52 employed in the DLP projector apparatus of the present invention. The modified diaphragm 52 has the construction similar to that of FIG. 4, except that only two blades 523 are used. The upper plate 524 has an inner peripheral portion confining the central hole, and two tongue-engaging recesses 5242 extending outwardly from the inner peripheral portion. Each of the blades 523 has an upwardly projecting tongue 5232 inserted into the respective tongue-engaging recess 5242 in the upper plate 524 for co-movement therewith with respect to the lower plate 522.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A projector apparatus comprising:
a light source for producing light beams;
a digital micromirror device for modulating said light beam emitted from said light source into photo signals;
an illuminating lens unit for guiding said light beams emitted from said light source towards said digital micromirror device;
an imaging lens unit for guiding and projecting said photo signals generated by said digital micromirror device out of said projector apparatus to present an image; and
at least an aperture-controllable diaphragm disposed within the projector apparatus, and defining an aperture, said aperture-controllable diaphragm including at least one adjustable blade for altering dimension of said aperture so as to adjust brightness and contrast of said image.

2. The projector apparatus according to claim 1, wherein said aperture-controllable diaphragm is mounted in said imaging lens unit.

3. The projector apparatus according to claim 1, wherein said aperture-controllable diaphragm is mounted in said illuminating lens unit.

4. The projector apparatus according to claim 1, wherein said aperture in said aperture-controllable diaphragm is shaped as an oval.

5. The projector apparatus according to claim 1, wherein said aperture in said aperture-controllable diaphragm is shaped as an eye.

6. The projector apparatus according to claim 1, wherein said aperture-controllable diaphragm includes lower and upper plates, each of which is formed with a central hole, and a fastener, said adjustable blade being sandwiched between said lower and upper plates, said upper plate further having a guiding slot formed therethrough, said fastener extending through said guiding slot in said upper plate, said adjustable blade and said lower plate, said upper plate further engaging said adjustable blade in such a manner that when said upper plate is rotated relative to said lower plate, said adjustable blade is driven by said upper plate to rotate about said fastener as a rotating center so as to alter the dimension of said aperture in said aperture-controllable diaphragm.

7. The projector apparatus according to claim 6, wherein said fastener is a screw.

8. The projector apparatus according to claim 6, wherein said upper plate has an inner peripheral portion confining said central hole and a tongue-engaging recess extending from said inner peripheral portion, said blade having an engagement tongue projecting upwardly to be inserted into said tongue-engaging recess in said upper plate for co-movement therewith with respect to said lower plate.

9. The projector apparatus according to claim 6, wherein said upper plate has a lower surface and an engaging tongue projecting downwardly from said lower surface, said blade having an upper surface formed with a tongue-engaging recess that is defined by a recess-confining wall, said tongue of said upper plate engaging said recess-confining wall of said tongue-engaging recess in said blade for co-movement therewith with respect to said lower plate.

10. An aperture-controllable diaphragm for use in a projector apparatus which includes a light source, a digital micromirror device for modulating the light beams emitted from the light source into photo signals, an illuminating lens unit for guiding the light beams from the light source towards the digital micromirror device, and an imaging lens unit for guiding and projecting the photo signals generated by the digital micromirror device out of the projector apparatus to present an image, the aperture-controllable diaphragm being disposed within the projector apparatus and defining an aperture, the aperture-controllable diaphragm comprising at least one adjustable blade for altering dimension of the aperture so as to adjust brightness and contrast of the image.

11. The aperture-controllable diaphragm according to claim 10, wherein the aperture-controllable diaphragm is mounted in the imaging lens unit.

12. The aperture-controllable diaphragm according to claim 10, wherein the aperture-controllable diaphragm is mounted in the illuminating lens unit.

13. The aperture-controllable diaphragm according to claim 10, wherein the aperture in the aperture-controllable diaphragm is shaped as an oval.

14. The aperture-controllable diaphragm according to claim 10, wherein the aperture in the aperture-controllable diaphragm is shaped as an eye.

15. The aperture-controllable diaphragm according to claim 10, wherein said aperture-controllable diaphragm includes lower and upper plates, each of which is formed with a central hole, and a fastener, said adjustable blade being sandwiched between said lower and upper plates, said upper plate further having a guiding slot formed therethrough, said fastener extending through said guiding slot in said upper plate, said adjustable blade and said lower plate, said upper plate further engaging said adjustable blade in such a manner that when said upper plate is rotated relative to said lower plate, said adjustable blade is driven by said upper plate to rotate about said fastener as a rotating center so as to alter the dimension of said aperture in said aperture-controllable diaphragm.

16. The projector apparatus according to claim 15, wherein said fastener is a screw.

17. The aperture-controllable diaphragm according to claim 15, wherein said upper plate has an inner peripheral portion confining said central hole and a tongue-engaging recess extending outwardly from said inner peripheral portion, said blade having an engagement tongue projecting upwardly to be inserted into said tongue-engaging recess in said upper plate for co-movement therewith with respect to said lower plate.

18. The aperture-controllable diaphragm according to claim 15, wherein said upper plate has a lower surface and an engaging tongue projecting downwardly from said lower surface, said blade having an upper surface formed with a tongue-engaging recess that is defined by a recess-confining wall, said tongue of said upper plate engaging said recess-confining wall of said tongue-engaging recess in said blade for co-movement therewith with respect to said lower plate.
